(19) United States
(12) Patent Application Publication
(10) Pub. No.: US 2009/0069192 A1
(43) Pub. Date: Mar. 12, 2009

(54) Microarray device for DNA recognition, apparatus using the microarray device, and corresponding method of operation

(76) Inventors: Bruno Ricco, Bologna (IT); Carlotta Guiducci, Bologna (IT); Luca Benini, Ferrara (IT)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 11/886,018

(22) PCT Filed: Mar. 10, 2006
(86) PCT No.: PCT/IB06/00531

§ 371 Date: Oct. 28, 2008

(30) Foreign Application Priority Data
Mar. 11, 2005 (IT) BO2005A000142

(51) Int. Cl. C40B 30/04; C40B 60/12

(52) U.S. Cl. 506/9; 506/39

(57) ABSTRACT

There is described a microarray device (1) for recognition of DNA in a material; the microarray device (1) comprising a plurality of microlocations (3), each of which is associated to a pre-set DNA sequence and is designed to be set in contact with a specimen of the material to carry out a process of hybridization with a corresponding DNA sequence contained in the specimen of the material itself; the microarray device (1) further comprises a plurality of microsensors (5), each of which is set in a position corresponding to a corresponding microlocation (3) and is designed to supply at output an electrical signal (S_{M}) indicating the absorption of ultraviolet radiation (UV) that occurs in the microlocation (3) when, following upon the hybridization process, the microlocation (3) itself is traversed by a beam of ultraviolet radiation (UV).

### TECHNICAL FIELD

The present invention relates to a microarray device for DNA recognition, to an apparatus for analysis using the microarray device, and to the corresponding method of operation.

### BACKGROUND ART

In current methods for fast DNA recognition, use is known of so-called DNA-microarrays, which are constituted by microfabricated devices, which enable the need of being able to perform a multiplicity of simultaneous analyses on a DNA specimen to be met in such a way as to supply in relatively short times the results of said analyses.

DNA microarrays currently in use, referred to hereinafter as “hybridization microarrays”, are made up of a solid support constituted by a thin layer of glass, silicon, quartz, or other appropriate material, made on which is a plurality of “detection sites or cells” of microscopic dimensions, referred to hereinafter as “microlocations”, each of which is associated to a pre-set DNA sequence.

In particular, the pre-set DNA sequence present in each of the microlocations of the hybridization microarray is constituted by a specific non-hybridized single-helix DNA probe typically immobilized on the surface of the solid support.

During the process of DNA recognition, following upon the step of polymerase-chain-reaction (PCR) amplification and dissociation of the two DNA helices of the sample material, the latter is set in contact with the microlocations in such a way as to enable the DNA probes of the microlocations themselves to hybridize or not with the individual complementary DNA helices of the specimen to be examined.

It should be specified that the term “hybridization” is meant to indicate a known biochemical process, whereby a pre-set DNA probe “binds” in a highly specific and selective way to the DNA to be examined, in the case where in the latter a sequence complementary to the pre-set probe itself is present.

FIG. 1 illustrates, in an extremely schematic way, some of the operations implemented by a method of DNA recognition using a hybridization microarray which is prevalently in use today.

Initially, the recognition method implements an operation I of “marking” the individual DNA helices of the sample material to be analysed. In detail, the DNA helices are marked with labels of fluorescent material typically referred to as “optical markers”.

Following upon the marking step, the sample material is set in contact with the microlocations present on the hybridization microarray to carry out an operation II of hybridization. In this step, all the microlocations of the hybridization microarray come into contact with the specimen of material to be analysed itself, the DNA sequences of which hybridize only with the complementary DNA probes immobilized on the microlocations.

In particular, on the microlocations in which the hybridization has occurred, a certain number of fluorescent markers present on the DNA specimen is immobilized, whilst the remaining “free” sequences present in solution, which have not undergone hybridization, are removed from the hybridization microarray so as to enable optical reading of the fluorescent markers immobilized on the microlocations themselves.

At this point, with the use of a microscope, an operation III of optical acquisition is performed of the two-dimensional image of the surface of the hybridization microarray on which the fluorescent markers that have remained immobilized in a position corresponding to the microlocations may be seen.

The image acquired is then supplied by the microscope to a processing unit, which, using a specific program for image processing, identifies the various fluorescent markers present on the hybridization microarray and, on the basis of the latter, performs DNA recognition of the specimen analysed.

The method of DNA recognition using the hybridization microarray described above presents various drawbacks.

In the first place, the operation of marking the individual helices of DNA of the material is an extremely critical stage of the method described above in so far as it can cause a contamination of the material to be examined, consequently introducing errors in the process of DNA recognition.

In addition, the method requires the use of extremely sophisticated and complex programs of image processing, and can currently be implemented only using different types of independent tools that are non-homogeneous with respect to one another (for example, microscopes, personal computers, etc.), which, in addition to being costly, depend heavily upon human intervention, consequently affecting the times required for analysis.

Finally, the method described above not only does not enable real-time DNA recognition, but does not even enable analyses to be performed with a sufficient degree of accuracy, it being consequently inadequate for carrying out analyses of a quantitative type.

### DISCLOSURE OF INVENTION

The aim of the present invention is consequently to provide a microarray device that will be able to overcome the drawbacks described above.

According to the present invention, a microarray device for DNA recognition is provided as indicated in Claim 1 and, preferably, in any one of the subsequent claims depending either directly or indirectly upon Claim 1.

According to the present invention, an apparatus for DNA recognition which uses a microarray device is moreover provided, as indicated in Claim 14.

Finally, according to the present invention a method for DNA recognition through a microarray device is provided, as indicated in Claim 19.

### BRIEF DESCRIPTION OF THE DRAWINGS

The present invention will now be described with reference to the annexed plate of drawings, which illustrate a non-limiting example of embodiment thereof, and in which:

FIG. 1 is a schematic illustration of a series of operating steps implemented in a method for DNA recognition via a hybridization microarray built according to the known art;

FIG. 2 is a schematic perspective view, with parts removed for reasons of clarity, of a microarray device made according to the teachings of the present invention;

FIGS. 3 to 8 are schematic illustrations of respective embodiments of the microarray device built according to the teachings of the present invention;

FIG. 9 is a schematic illustration of an optical-amplification device comprised in the microarray device illustrated in FIG. 1;

FIG. 10 shows the time evolution of the threshold voltage in a memory cell, when the latter is impinged upon by a beam of ultraviolet radiation;

FIG. 11 is a schematic illustration of an apparatus for DNA recognition built according to the teachings of the present invention; whilst

FIG. 12 is a schematic illustration of the method for DNA recognition provided according to the teachings of the present invention.

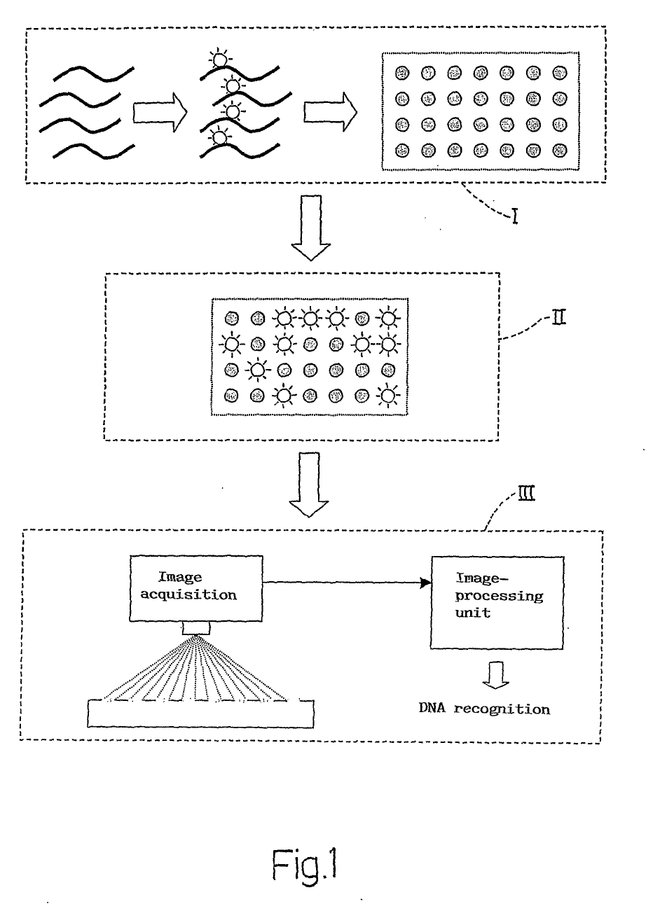

### BEST MODE FOR CARRYING OUT THE INVENTION

The present invention is essentially based upon the principle of emitting, after the step of hybridization of the DNA, one or more beams of ultraviolet radiation towards the microlocations present on the hybridization microarray, and detecting via a detection microarray that is integrated or can be suitably coupled to the hybridization microarray, the absorption of ultraviolet radiation by each microlocation when the latter is traversed by the beam of ultraviolet radiation.

In other words, the present invention is essentially based on the idea of measuring the difference of absorption of ultraviolet radiation by the DNA of a material (or fragments thereof) according to whether the latter is or not in a state of hybridization, i.e., whether it is present in the form of a single or double helix.

It should be pointed out that said difference of absorption of ultraviolet radiation, which will be referred to hereinafter as “differential absorption”, may occur as final effect of two different processes of hybridization. In the case in point, a first process gives rise to the so-called “hypochromic effect”, by virtue of which hybridization of the DNA, given the same amount of material, causes a reduction of the absorption of ultraviolet radiation (approximately 30%). It is evident then that, in this case, the identification of the microlocations that have a reduced absorption of radiation renders possible discrimination of the hybridized DNA sequences from the non-hybridized ones.

The second process, instead, which is independent of the hypochromic effect and is of more general application, occurs when the hybridization takes place with DNA probes immobilized in a microlocation. In this case, following upon hybridization the solution to be analysed by the hybridization microarray is removed, and remaining in the microlocations in which the hybridization has occurred is material in excess that comprises the hybridized DNA that has remained “anchored” to the complementary DNA probe. Said excess of material in the hybridized microlocations causes an increase of the absorption of ultraviolet radiation in areas corresponding to the microlocations themselves with respect to the absorption that occurs in the microlocations where hybridization has not occurred. It is evident then, that in this case, by identifying the microlocations that have a greater absorption of radiation, it is possible to discriminate the hybridized DNA sequences from the non-hybridized ones.

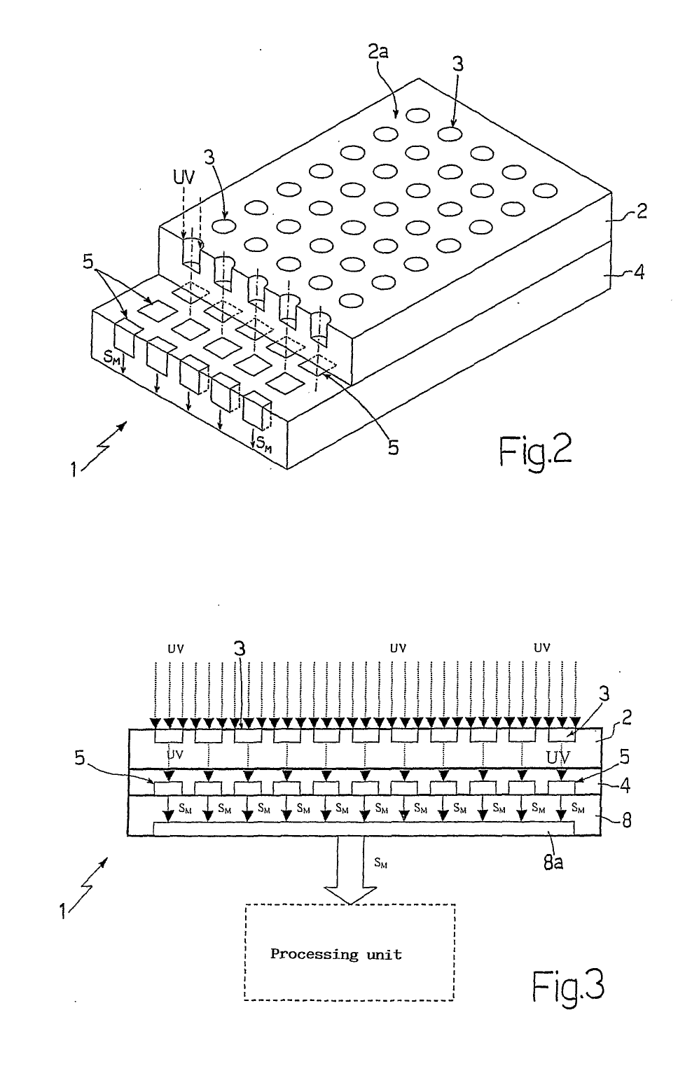

With reference to FIGS. 2 to 8, number 1 designates as a whole a microarray device, which basically comprises a hybridization microarray 2 provided with a plurality of microcells or microlocations 3, each associated to a specific DNA sequence; and a detection microarray 4, which is appropriately coupled to the hybridization microarray 2 and is provided with a plurality of microsensors 5 of ultraviolet radiation, each of which is designed to supply an electrical signal S_{M} corresponding to the absorption of ultraviolet radiation by a corresponding microlocation 3 present in the hybridization microarray 2.

In the example illustrated in FIG. 2, the hybridization microarray 2 is provided with a preferably, but not necessarily, plane solid support, which can be made of at least one thin layer of glass, silicon, quartz, plastic or any other similar material typically used in the techniques of microfabrication of electronic chips.

The microlocations 3 are positioned on the outer surface 2a of the solid support, which is designed in use (as will be described in detail hereinafter) to be impinged upon by a beam of ultraviolet radiation, referred to hereinafter for reasons of brevity with the term “UV radiation”. It should be pointed out that the UV beam can present a spectrum of radiation having a pre-set wavelength comprised substantially between 200 and 400 nm.

With reference to the example illustrated in FIG. 2, in particular the microlocations 3 are distributed on the outer top surface 2a with an appropriate density, (which can for example be of the order of hundreds, thousands, or hundreds of thousands of microlocations per square centimetre) preferably according to a geometrical matrix or grid configuration, in which each microlocation 3 is associated to a given row-column combination of the array.

As regards the detection microarray 4, it is provided with a solid, preferably plane, support, which can be made of a layer of glass, silicon, quartz, or any other similar material typically used in the techniques of microfabrication of electronic chips, and is designed to be coupled to the solid layer of the hybridization microarray 2 on the side opposite to the surface 2a impinged upon in use by the UV radiation, in such a way as to present each microsensor 5 aligned with the corresponding microlocation 3 of the hybridization microarray 2 in a direction corresponding to the optical path followed by the UV radiation.

In the example illustrated in FIG. 2 in particular, the microsensors 5 are aligned with the respective microlocations 3 in a vertical direction, in such a way as to be able to receive each only the portion of the beam of ultraviolet radiation that traverses the respective microlocation 3 so as to be able to measure the absorption of UV radiation that occurs in the microlocation 3 itself.

The microsensors 5 are arranged on the solid support of the detection microarray 4 preferably according to a geometrical matrix or grid configuration altogether equivalent to the geometrical matrix configuration presented by the microlocations 3 on the surface 2a of the hybridization microarray 2 in such a way that each microsensor 5 will be perfectly aligned to the corresponding microlocation 3 and associated to a given row-column combination of its own array. With reference to the example illustrated in FIGS. 3, 4 and 5, the microarray device 1 further comprises, preferably but not necessarily, a reading microdevice 8, which has the function of co-ordinating the “electrical” detection of the electrical signals S_{M} generated by the microsensors 5 present in the detection microarray 4, to supply the electrical signals S_{M} themselves to a processing unit described in detail hereinafter, which has the function of processing the electrical signal S_{M} to supply the indication regarding the DNA of the material examined.

In particular, the reading microdevice 8 is able to co-ordinate reading of the electrical signals S_{M} generated by the microsensors 5 via an appropriate system of row-column addressing, which enables unique identification of each microsensor 5 on the corresponding array so as to be able co-ordinate reading of the absorption of the UV radiation in each point in a selective way.

The reading microdevice 8 is moreover able to treat, i.e., condition or amplify appropriately the electrical signals S_{M} that it receives from the microsensors 5 of the detection microarray 4, to be able to supply them at output according to a pre-set electrical format so as to enable the processing unit to receive and read the electrical signals S_{M}.

In the example illustrated in FIGS. 3, 4 and 5, the reading microdevice 8 is provided with a solid, preferably plane, support, which can be made with a thin layer of glass, silicon, quartz, or any other similar material typically used in the techniques of microfabrication of electronic chips, within which one or more electronic microcircuits 8a are integrated, which are designed to be electrically connected to the microsensors 5 in order to receive at input the electrical signals S_{M} produced by the latter, and are able to perform the different functions of addressing of the microsensors 5, and of treatment of the electrical signals S_{M} during acquisition of the latter by a processing unit.

In the example illustrated in FIG. 3, the hybridization microarray 2, the detection microarray 4, and the reading microdevice 8, which make up the microarray device 1, are integrated with one another in such a way as to provide a monolithic chip, in which the detection microarray 4 is stably fixed to the hybridization microarray 2, and the reading microdevice 8 is in turn stably fixed to the detection microarray 4. In the case in point, the integration can envisage, for example, that the hybridization microarray 2, the detection microarray 4, and the reading microdevice 8 are made “in layers” with technologies typical of microfabrication or integrated circuits.

It is evident that the hybridization microarray 2, the detection microarray 4, and the reading microdevice 8 that make up the microarray device 1 can be completely separate from one another or integrated in pairs according to different possible combinations.

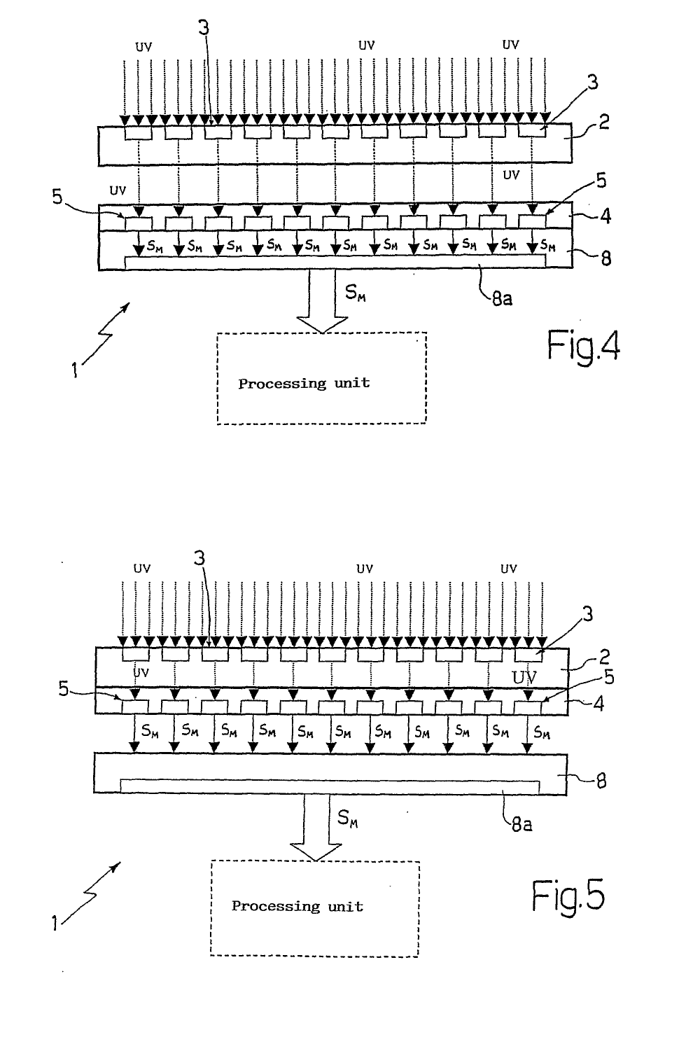

For example, according to an embodiment illustrated in FIG. 4, the detection microarray 4 and the reading microdevice 8 are integrated with one another in such a way as to form a single monolithic chip, whilst the hybridization microarray 2 is separate and independent therefrom and is designed, in use, to be coupled to the detection microarray 4.

It is evident that in this case the coupling between the hybridization microarray 2 and the detection microarray 4 can be obtained, for example, by setting the solid support of the hybridization microarray 2 directly resting on the top surface of the solid support of the detection microarray 4 in such a way as to provide a vertical alignment between the microsensors 5 of the detection microarray 4 and the corresponding microlocations 3 of the hybridization microarray 2.

In the case in point, following upon the aforementioned alignment, each microsensor 5 of the detection microarray 4 is set immediately underneath a corresponding microlocation 3 in such a way as to be able to detect the portion of the beam of ultraviolet radiation that traverses the microlocation 3 itself.

According to a different embodiment illustrated in the example of FIG. 5, the detection microarray 4 and the hybridization microarray 2 are integrated with one another in such a way as to form a single monolithic chip, whilst the reading microdevice 8 is separate and independent therefrom and is designed, in use, to be coupled to the detection microarray 4 in such a way as to be able to receive at input the electrical signals S_{M}.

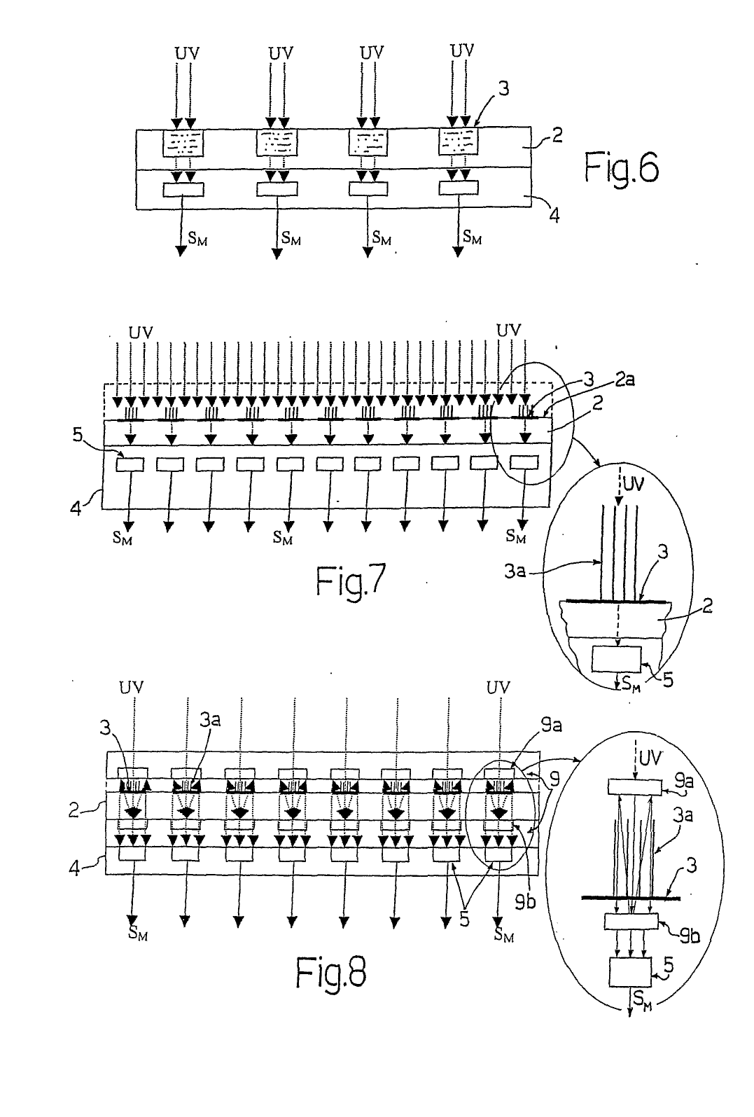

With reference to FIG. 6, each microlocation 3 of the hybridization microarray 2 is defined by a microsump of capillary dimensions, which is made on the top surface 2a of the layer of the hybridization microarray 2 and is designed to contain inside it a solution containing in turn one or more specific DNA probes. In the case in point, the solution containing the DNA probe or probes can be constituted by a liquid solution and/or a “dry” solution.

According to a different embodiment illustrated schematically in FIGS. 7 and 8, each microlocation 3 of the hybridization microarray 2 comprises a pre-set plurality of DNA probes that are identical to one another (numbering four in FIGS. 7 and 8), each of which is immobilized appropriately on the top surface 2a of the hybridization microarray 2.

Each specific DNA probe, designated by the number 3a, comprises a plurality of monomolecular layers deposited on the surface 2a of the solid support via an appropriate intermediate linker layer in the “immobilized” form. In the case in point, the pre-set DNA probes are “immobilized” in the microlocations 3 by means of known techniques, which use a series of layers of different material for creating suitable bonds, for example of a multiple type between a substrate and an intermediate (linker) layer, and between the latter and each pre-set DNA probe. In greater detail, the location of the pre-set DNA probes on each specific microlocation 3 can be obtained both with precise positioning systems, for example using the technology of precision ink-jet printers, and by means of successive “maskings”, as in traditional lithographic techniques.

Conveniently, in one of the possible embodiments described above (FIG. 5), in which the hybridization microarray 2 and the detection microarray 4 are made together “in layers” according to technologies typical of microfabrication, the surface 2a of the hybridization microarray 2, on which the pre-set DNA probes are immobilized, may also be constituted by means of an outer passivation of a chip.

With reference to FIG. 8, the hybridization microarray 2 further comprises preferably, but not necessarily, an optical-amplification device 9, which has the function of causing the UV beam to interact a number of times with the DNA probes 3a containing the monomolecular layers in such a way as to bring about an increase in the differential absorption of ultraviolet radiation by the DNA probes in the case where hybridization of the DNA with the probes themselves occurs.

In particular, the optical-amplification device 9 can comprise a series of reflecting and/or half-reflecting mirrors, designed to perform the operations of reflection and hence of amplification of the UV beam towards the DNA probes present in the microlocations 3.

In the example illustrated schematically in FIG. 8, the optical-amplification device 9 comprises a plurality of half-reflecting mirror microelements, which are arranged in pairs in a position corresponding to each microlocation 3. In the case in point, each pair of mirror microelements associated to a microlocation 3 comprises a first mirror microelement designated by 9a, which is set on top of, and facing, the microlocation 3, and a second mirror microelement designated by 9b, which is set immediately underneath the microlocation 3. The mirror microelements 9a and 9b are preferably half-reflecting in such a way as to be able to be traversed by the UV beam and at the same time partially reflect the UV radiation towards the DNA probes of the microlocation 3.

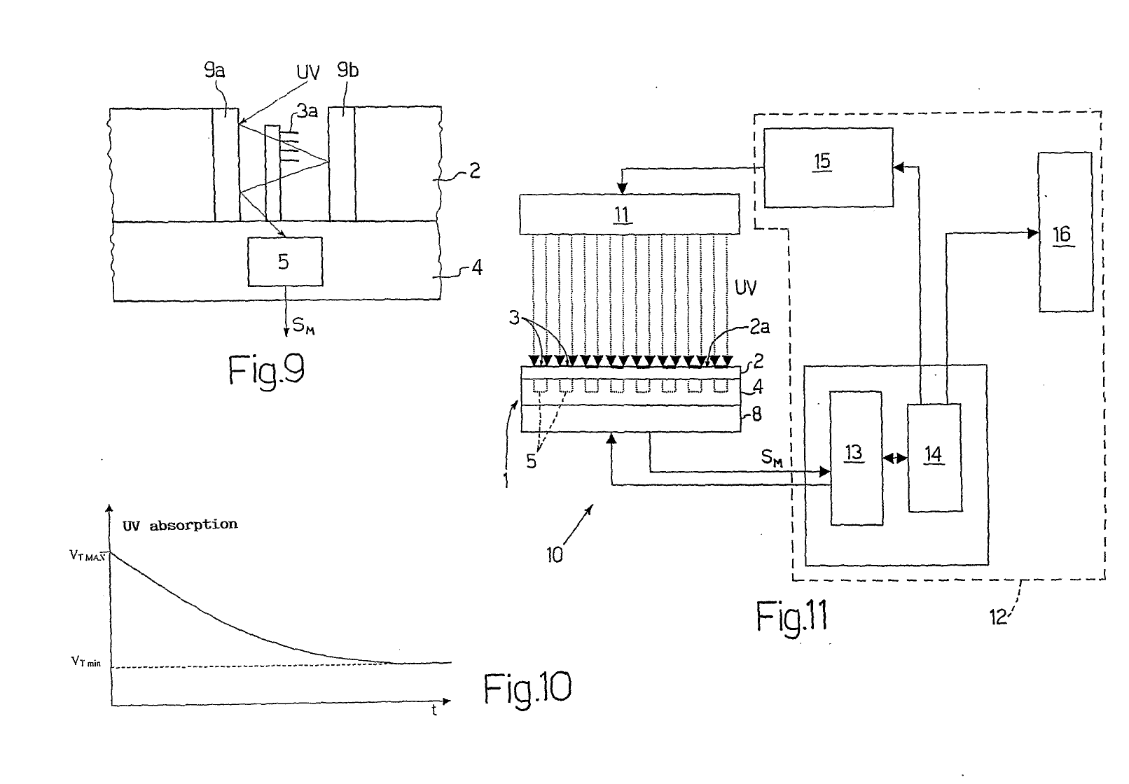

According to a variant illustrated in FIG. 9, in each microlocation 3, the first and the second mirror microelements 9a, 9b are completely reflecting and are arranged in positions parallel to one another in such a way as to cause the UV beam to interact a number of times in a direction substantially transverse to the DNA probes 3a present in the microlocation 3 and having the same DNA sequence so as to determine an amplification of the differential absorption on the DNA sequences.

It should be pointed out that, in this case, the UV beam is emitted in a direction substantially transverse to the surface plane of at least one of the two mirror microelements 9a, 9b, which reflect to one another the radiation in such a way as to impinge upon the DNA probes and “convey” the radiation itself towards the microsensor 5.

As regards, instead, the microsensors 5 of the detection microarray 4, they can be made up preferably, but not necessarily, of storage devices, such as, for example, non-volatile memory cells (not illustrated).

It is known in fact that the memory cells, following upon programming thereof (corresponding to the operation of writing) remain in a stable condition, in which they have a pre-set voltage threshold, typically high, and that the “erasure” of the information contained in the memory cell, is performed by irradiating the cell itself with a UV beam.

During irradiation of the memory cell with the UV radiation, the voltage threshold of the memory cell decreases progressively as a function of the quantity of UV radiation received. Indicated by way of example in FIG. 10 is a typical time evolution of the value of the voltage threshold of a memory cell as a function of the exposure of the memory cell itself to UV radiation.

It is evident then that the memory cell supplies at output an electrical signal that has a voltage proportional to the quantity of UV radiation that impinges upon the cell itself, performing in this specific case the same function as a UV sensor.

In particular, each memory cell used in the specific case as microsensor 5 of UV radiation present in the detection microarray 4 can be preferably, but not necessarily, made according to CMOS technology. In the case in point, each microsensor 5 can be formed by a memory cell of an EPROM or EEPROM type made preferably in the “single poly level” form. The memory cells that make up the microsensors 5 described above are known and consequently will not be described further herein.

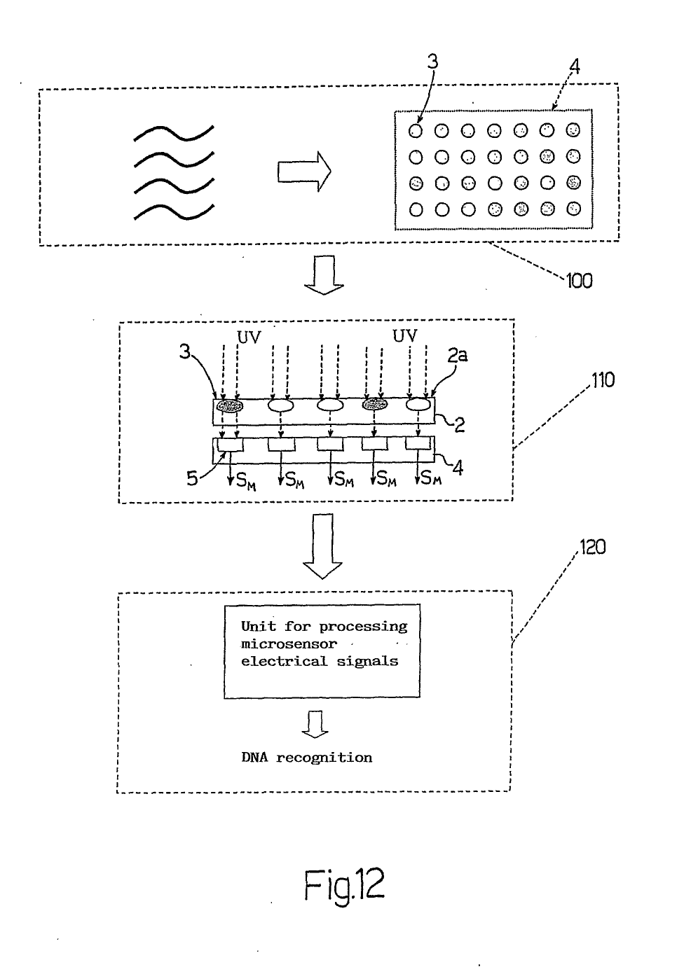

With reference to FIG. 11, an apparatus 10 for DNA recognition using at least one microarray device 1 described above is illustrated.

In the example illustrated in FIG. 11, in addition to the microarray device 1 described above, the apparatus 10 comprises preferably, but not necessarily, a source 11 of UV radiation, which can be constituted, for example, by a UV-laser emitter device, or by a UV lamp, or by any other similar type of apparatus designed to emit a UV beam in the direction of the outer surface 2a of the microarray device 1 in such a way as to illuminate the array of the microlocations 3.

The apparatus 10 further comprises a processing unit 12, which is designed to receive and process the electrical signals S_{M} generated by the microsensors 5 following upon illumination of the microlocations 3, in such a way as to supply, on the basis of said processing, a set of information regarding DNA recognition of the material analysed.

In the case in point, the processing unit 12 is able to process the electrical signals S_{M} generated by the microsensors 5 to identify the microlocations 3, i.e., the specific DNA probes, which during the process of hybridization have “bound” to the complementary sequences of the DNA analysed, hence distinguishing them from the microlocations 3, i.e., from the DNA probes that have remained “free”.

From the foregoing description, it should be pointed out that the processing implemented by the processing unit 12 is essentially based upon differential absorption (described previously), by virtue of which it is possible to distinguish the microlocations 3 on which the hybridization by the other microlocations 3 has occurred, analysing the absorption of UV radiation by them.

Consequently, the processing unit 12 calculates, according to each electrical signal S_{M}, the absorption of UV radiation that occurs in each microlocation 3, and according to said absorption is able to establish whether hybridization of the corresponding DNA probe has occurred or not in the microlocation 3 itself.

Once identified and discriminated, the hybridized microlocations 3 from the “non-hybridized” microlocations 3, the processing unit has available all the information sufficient for complete DNA recognition.

On the basis of the foregoing description, it should be added that the apparatus 10, in addition to carrying out DNA recognition, is able to perform advantageously an analysis of a quantitative type on the DNA specimen in such a way as to determine the effective “concentration” of DNA in the material examined.

Said concentration can in fact be detected by emitting the UV beam in the direction of a hybridization microarray 2, in which the microlocations 3 comprise a plurality of DNA probes that have one and the same DNA sequence but have a pre-set differentiated DNA concentration.

In this case, the pre-set concentrations of DNA present in the DNA probes present in the microlocations 3 determine, following upon hybridization with the complementary probes of the material analysed, different absorptions of UV radiation, on the basis of which it is possible to identify and hence discriminate the DNA probes that have hybridized with complementary probes having a concentration of DNA greater than a certain threshold from the DNA probes that have hybridized with complementary probes having a concentration of DNA lower than the threshold itself.

It is therefore evident that in this case the processing unit 12 of the apparatus 10 calculates, according to each electrical signal S_{M}, the absorption of UV radiation that occurs in each microlocation 3, and, according to said absorption, is able to determine the concentration of DNA present in the material examined.

The processing unit 12 can comprise: an electronic circuit provided with an interface module 13 that is able to manage acquisition and the reading of the electrical signals S_{M} generated and supplied by the microsensors 5 through the reading microdevice 8; and a computation module 14, constituted, for example, by a microprocessor, which processes each signal S_{M} to detect the absorptions of the microlocations 3, so as to identify the hybridized microlocations 3.

From the foregoing description, it should be pointed out that the electrical coupling and/or connection between the microarray device 1 and the interface module 13 can be made in different ways according to the embodiment of the microarray device 1.

The microarray device 1 and/or each of its components described above, in particular the reading microdevice 8, according to the embodiment can in fact be fixed and electrically connected in a removable or fixed way to the interface module 13.

The processing unit 12 may further comprise preferably, but not necessarily, a control module 15, which is able to drive the source 11 appropriately during emission of the UV beam, and a display device 16 for example a monitor or a display able to display the information regarding DNA recognition.

From what has been set forth above, it should be pointed out that the method of DNA recognition using the microarray device 1 described above, which can be implemented by the apparatus 10 of analysis, comprises the steps described in what follows.

With reference to FIG. 12, following upon the step of hybridization (dashed block designated by 100) between a specimen of the material to be examined and the specific DNA probes present in the microlocations 3 of the microarray device 1, activation of the source 11 that emits a UV beam towards the surface 2a of the microarray device 1 is controlled in such a way as to irradiate the microlocations 3.

In this step, the UV radiation generated by the source 11 follows a pre-set optical path that traverses the surface 2a in such a way as to impinge upon each microlocation 3. It is evident that, should the microarray device 1 be provided with the optical-amplification device 9 (arrangement indicated in FIG. 6), the UV radiation, following upon traversing of the surface 2a, is reflected partially by the mirror elements 9a and 9b, causing a controlled amplification of the differential absorption on each microlocation 3.

Each microsensor 5 of the detection microarray 4 detects the UV radiation absorbed by the corresponding microlocation 3, to supply at output the electrical signal S_{M} indicating the absorption of UV radiation by the microlocation 3 itself (dashed block designated by 110).

At this point, the reading microdevice 8 of the microarray device 1 co-ordinates acquisition of the electrical signals S_{M}, to supply them at input to the processing unit 12, which processes them to recognize the DNA of the specimen of the material being analysed (dashed block designated by 120). In particular, in this step the processing unit 12 calculates according to the electrical signals S_{M} the differential absorption that has occurred in each microlocation 3 and, on the basis of the latter, discriminates the microlocations 3 containing the specific DNA probes affected by hybridization from the microlocations 3 containing the specific non-hybridized DNA probes.

Once the discrimination is completed, the processing unit 12 is able to supply, through the display device 16, the indications regarding DNA recognition of the material examined.

It should be added that, in the case where the microlocations 3 of the hybridization microarray contain specific DNA probes having the same DNA sequence but a differentiated concentration, the processing unit 12 is able to determine, as a function of the differential absorption that has occurred in each microlocation 3, the concentration of DNA of the material being analysed (associated to the known DNA sequence).

The method of DNA recognition using the microarray device 1 described above affords the major advantage of not requiring any process of marking of the material to be analysed with fluorescent optical markers, thus eliminating completely any possibility of contamination of the material itself prior to its analysis.

The microarray device 1 described above moreover presents potentially very low production costs and consequently leads to a considerable reduction in the costs involved in DNA recognition. For example, in the embodiment described above, where the separation of the hybridization microarray 2 from the remaining components is envisaged, the hybridization microarray can be of the disposable type.

In the case in point, as already anticipated, the hybridization microarray 2 can be each time set resting on the detection microarray 4, thus enabling the microsensors 5 to measure the UV radiation absorbed by the microlocations 3.

Finally, the microarray device 1 could advantageously be integrated in a multifunctional structure that comprises elements for control and handling of the DNA specimen, such as for example an integrated system of microfluidic channels for movement of the specimen in solution and its passage according to a correct dynamics in the area corresponding to the microlocations, or else an integrated system of temperature control for optimization of the reaction of molecular recognition in terms of specificity and efficiency. Said control could be implemented so as to be able to act both locally and globally in regard to the device. Said integration of the microarray device 1 in one of the systems mentioned above in fact enables a greater facility of use for the user, increases the portability of the system of analysis, and finally improves the performance thanks to a greater control of the physico-chemical parameters of the reaction of recognition between receptors and target molecular species.

Finally, as regards the apparatus 10, in addition to not requiring high computing powers in so far as the method described above eliminates the need to perform image processing, performs DNA recognition in “real time” and affords the possibility of detections also of a quantitative type.

Finally, it is clear that modifications and variations can be made to the microarray device 1, to the apparatus 10, and to the method of DNA recognition described and illustrated herein, without thereby departing from the scope of the present invention, defined by the annexed claims.

1. A microarray device (1) for recognition of DNA in a material, said microarray device comprising a plurality of microlocations (3), each of which is associated to a pre-set DNA sequence, and is designed to be set in contact with a specimen of said material, to carry out a process of hybridization with a corresponding DNA sequence contained in the specimen of the material itself; said microarray device being characterized in that it comprises a plurality of microsensors (5), each of which is set in a position corresponding to a relevant microlocation (3) and is designed to supply at output an electrical signal (S_{M}) indicating the absorption of ultraviolet radiation (UV) that occurs in the microlocation (3) when, following upon said process of hybridization, the microlocation (3) itself is traversed by a beam of ultraviolet radiation (UV).

2. The microarray device according to claim 1, characterized in that it comprises at least one first plane solid support; said microlocations (3) being arranged on an outer surface (2a) of said at least one first plane solid support, designed to be impinged upon by said beam of ultraviolet radiation (UV).

3. The microarray device according to claim 2, characterized in that each microlocation (3) comprises a microsump, which is made on said outer surface (2a) of said first solid support, and is designed to contain inside it a solution containing in turn at least one pre-set DNA probe.

4. The microarray device according to claim 2, characterized in that each microlocation (3) comprises at least one pre-set DNA probe, in turn comprising a plurality of pre-set monomolecular layers, which are arranged on said outer surface (2a) of the first solid support in an immobilized form.

5. The microarray device according to claim 4, characterized in that it comprises optical-amplification means (9), which are designed to cause said beam of ultraviolet radiation (UV) to interact a number of times with said specific DNA probes in such a way as to bring about an increase in the absorption of ultraviolet radiation (UV) by the DNA probes themselves.

6. The microarray device according to claim 2, characterized in that it comprises at least one second plane solid support; said microsensors (5) being integrated in said second plane solid support; said second solid support being designed to be fixed to said first solid support in such a way that each said microsensor (5) will be underneath, and aligned to, a corresponding microlocation (3) with respect to said outer surface (2a).

7. The microarray device according to claim 1, characterized in that it comprises electronic reading means (8), which are electrically connected to said microsensors (5) in order to receive at input said electrical signals (S_{M}); said electronic reading means (8) being designed to co-ordinate activation of each microsensor (5) and to treat appropriately each said electrical signal (S_{M}) in order to supply it at output in a pre-set electrical format.

8. The microarray device according to claim 7, characterized in that it comprises at least one third plane solid support; said reading means (8) being integrated in said third solid support.

9. The microarray device according to claim 8, characterized in that said second and third plane supports are fixed to one another in such a way as to provide a single monolithic chip.

10. The microarray device according to claim 8 claim 9, characterized in that said first, second, and third plane supports are fixed to one another in such a way as to provide a monolithic chip.

11. The microarray device according to claim 8, characterized in that said first and second plane supports are fixed to one another in such a way as to provide a single monolithic chip.

12. The microarray device according to claim 1, characterized in that each of said microsensors (5) comprises a memory cell.

13. The microarray device according to claim 1 characterized in that said microlocations (3) comprise a plurality of DNA probes (3a), which have one and the same DNA sequence but have a pre-set differentiated DNA concentration.

14. An apparatus (10) for recognition of DNA in a material, characterized in that it comprises at least one microarray device (1) built according to claim 1, and processing means (12), which are designed to receive and process the electrical signals (S_{M}) generated by the microsensors (5) to carry out according to said signals recognition of the DNA of the material being analysed.

15. The apparatus according to claim 14, characterized in that it comprises at least one source (11) for emission of radiation designed to emit a beam of ultraviolet radiation (UV) in the direction of the outer surface (2a) of the microarray device (1) in such a way as to irradiate said microlocations (3).

16. The apparatus according to claim 14, characterized in that said processing means (12) are designed to process said electrical signals (S_{M}), generated by said microsensors (5), to identify the microlocations (3) present in said microarray device (1) on which the hybridization of the pre-set DNA sequences has occurred; said processing means (12) being designed to perform DNA recognition of the material analysed according to the hybridized microlocations (3) identified.

17. The apparatus according to claim 15, characterized in that said processing means (12) are designed to process said electrical signals (S_{M}) in order to calculate the absorption of ultraviolet radiation (UV) in each hybridized microlocation (3); said processing means (12) being designed to determine the concentration of DNA of the material as a function of the absorption of ultraviolet radiation (UV) in the hybridized microlocation (3).

18. The apparatus according to claim 15, characterized in that it comprises display means (16), designed to display the information regarding DNA recognition.

19. A method for recognition of DNA in a material via at least one microarray device (1) built according to claim 1; said method being characterized in that it comprises the steps of:
following upon the step of hybridization (100) between a specimen of said material and said DNA sequences present in said microlocations (3) of the microarray device (1), generating a beam of ultraviolet radiation (UV) in the direction of the outer surface (2a) of said microarray device (1) in such a way as to irradiate said microlocations (3);
detecting (110) via the microsensors (5) of said microarray device (1) the ultraviolet radiation (UV) absorbed by each microlocation (3) to supply a plurality of electrical signals (S_{M}), each indicating the absorption of ultraviolet radiation (UV) by a corresponding microlocation (3); and
processing (120) said electrical signals (S_{M}), each indicating the absorption of ultraviolet radiation (UV) by a corresponding microlocation (3) of said microarray device (1), to recognize, according to said absorption of ultraviolet radiation (UV), the DNA of the specimen of the material being analysed.

20. The recognition method according to claim 19, characterized in that the step of signal processing (120) comprises the step of identifying, as a function of the absorption of ultraviolet radiation (UV) by each microlocation (3), the microlocations (3) of said microarray device (1) on which the hybridization of the pre-set DNA sequences has occurred, to recognize, according to said microlocations (3) identified, the DNA of the specimen of the material being analysed.

21. The recognition method according to claim 19, characterized in that it comprises the step of multiplying, via optical-amplification means (9), the optical interaction between said beam of ultraviolet radiation (UV) and said specific DNA sequences associated to said microlocations (3), in such a way as to amplify the absorption of ultraviolet radiation (UV) in the microlocations (3) themselves.

22. The recognition method according to claim 21, characterized in that said step of multiplying the optical interaction comprises the step of reflecting said ultraviolet radiation (UV) between at least two mirror elements (9a, 9b) arranged in a position corresponding to each of said microlocations (3) so that they face one another and are set at a distance from one another in such a way that each impinge upon the microlocations (3) themselves a number of times with the ultraviolet radiation (UV).

23. The recognition method according to claim 19, in which the microlocations 3 of the microarray device comprise a plurality of DNA probes (3a), which have one and the same DNA sequence but have a pre-set differentiated DNA concentration; said method being characterized in that said step of signal processing (120) comprises the step of determining the concentration of DNA of the material being examined as a function of the absorption of ultraviolet radiation in each of said microlocations (3).
